(19) United States
(12) Patent Application Publication
(10) Pub. No.: US 2026/0064087 A1
(43) Pub. Date: Mar. 5, 2026

(54) Management System With Platform For Coordinated Device Operation

(71) Applicant: Applied Electric Vehicles Ltd, Scoresby (AU)

(72) Inventors: Marc Alexander, Croydon Hills (AU); Aleks Witko, Mont Albert (AU); Laksh Jaisinghani, Carrum Downs (AU)

(73) Assignee: Applied Electric Vehicles Ltd, Scoresby, VI (AU)

(21) Appl. No.: 18/820,871

(22) Filed: Aug. 30, 2024

(51) Int. Cl. G05B 13/02

(52) U.S. Cl. CPC G05B 13/0265

(57) ABSTRACT

A management system implements a platform operable to receive input specifying operation objectives for a target system. The management system employs a machine-learning model to process the operation objectives and generate commands for devices of the target system based on the operation objectives. The operation objectives are provided to the machine-learning model as natural language input in some instances. The commands are executed by the devices in order to coordinate operation of the devices and satisfy the operation objectives.

### BACKGROUND

Some systems, such as facility systems, employ various devices to maintain and/or adjust system conditions. Such devices can be operated manually and/or can support simple automatic operation. For example, a system including a facility may employ doors, lights, air conditioning units, and/or other devices that support access to the facility, maintaining or adjusting air quality within the facility, and other aspects of the system. The automatic operation of such devices is often performed by utilizing outputs of thermostats, motion sensors, and/or other types of sensors that are configured to interface with the devices. However, the automatic operation is often limited to simple responses based on a configuration of the devices and the sensor outputs, such as adjustment of a device from an activated condition to an inactivated condition or vice versa. Additionally, the automatic operation of devices does not account for situations in which devices interfere with each other while operating and/or cause other undesired outcomes, such as a reduced efficiency of one device resulting from operation of another device.

### BRIEF DESCRIPTION OF THE DRAWINGS

FIG. 1 illustrates a non-limiting example environment which employs a management system with a platform for coordinated device operation.

FIG. 2 is a block diagram of a non-limiting example of generation of commands for a target system via a management system implementing a platform for coordinated device operation.

FIG. 3 is a block diagram of another non-limiting example of generation of commands for a target system via a management system implementing a platform for coordinated device operation.

FIG. 4 is a block diagram of a non-limiting example of a computing device in electronic communication with a management system implementing a platform for coordinated device operation.

FIG. 5 is a block diagram of a non-limiting example of a target system in electronic communication with a management system implementing a platform for coordinated device operation.

FIG. 6 is a block diagram of a non-limiting example of external devices in electronic communication with a management system implementing a platform for coordinated device operation.

FIG. 7 depicts a procedure for implementing a platform for coordinated device operation.

FIG. 8 illustrates an example system that includes an example computing device that is representative of one or more computing systems and/or devices for implementing the various techniques described herein.

### DETAILED DESCRIPTION

Systems that include facilities such as warehouses, service stations, retail spaces, homes, garages, or other types of buildings often include multiple devices configured for different purposes. Such devices may include, for example, security cameras, locks, doors, gates, lights, speakers, air conditioning, heating, alarms, powered windows, etc. However, coordinating operation of devices in order to support effective operation of a facility can be challenging, and operation of some devices can interfere with other devices and/or result in reduced efficiency of other devices.

For example, a device such as a door may be configured to open or close automatically based on an output of a motion sensor or an obstruction sensor (e.g., a laser sensor, infrared sensor, etc.). However, in situations in which the door is repeatedly opened (e.g., responsive to a user remaining within a detection range of a sensor configured to cause the door to open), another device configured to maintain a temperature, particulate level, or other quality of air within the facility may struggle to do so in an efficient manner due to a flow of air through the door. Further, in some situations, access to the facility through the door may be authorized for particular individuals, while access for other individuals is not authorized. However, ensuring that the door is automatically opened for authorized individuals (e.g., via scanning of credentials and/or identifying the individuals via one or more cameras) while preventing unauthorized individuals from entering the facility while the door is opened for the authorized individuals may be difficult or impossible using conventional approaches.

Additionally, devices within such systems often have different makes or models. For example, within a given system, two devices of a same type (e.g., two cameras, two powered doors, etc.) may have different manufacturers. As a result, the devices may operate differently and/or have different available functions. It may be difficult or impossible with conventional approaches to control the devices together due to differences between the inputs each device is configured to accept. In some cases, electronic signals or other inputs that are recognized by one device are not recognized by another device. Thus, although the devices may be operated individually, coordination of the devices may be limited or nonexistent. Such situations can result in unpredictable behaviors and/or interferences between the different devices. In some situations, such as the example in which two powered doors have different manufacturers, operation characteristics of one door may not be consistent with operation characteristics of the other door. For example, a speed of opening one door may be faster than a speed of opening another door (e.g., twice as fast). This lack of coordination of the devices may lead to efficiency losses of the system and increased costs associated with power usage, wear, etc.

In accordance with the techniques of this disclosure, a management system implementing a platform for coordinated device operation is described herein. The platform facilitates coordination of multiple devices of a target system through use of a machine-learning model trained to generate commands to be communicated to the devices. To do so, the machine-learning model receives operation objectives for the devices and generates the commands for the devices based on the operation objectives. The operation objectives may be received via user input to the platform and may be natural language descriptions of objectives to be met by the target system.

In some implementations, the machine-learning model determines the devices to receive the commands based on a content of the operations objectives. For example, the operation objectives may specify a target condition for the target system, such as a condition including reduced electrical power usage of a facility of the target system with heightened security. Responsive to processing the operation objectives, the machine-learning model identifies one or more devices of the target system to be controlled to meet the aforementioned target condition. For example, based on the target condition of prioritizing security, the machine-learning model may identify one or more doors of the facility to receive commands. The commands for the identified devices are generated by the machine-learning model control the one or more doors to satisfy the target condition of reduced electrical power usage of the target system while ensuring that the facility is secure from unauthorized access.

In some implementations, one or more of the devices is controlled via a respective application encoded with a respective application programming interface (API). The application associated with a device may be stored in a memory of the device. The management system may receive data describing each API associated with each device and the machine-learning model may generate the commands based on the APIs such that the commands are readable by the devices.

In some implementations, the management system virtually simulates operation of the devices using the device constraints. The machine-learning model may be trained based on the simulated operation of the devices. Training the machine-learning model based on the simulated operation of the devices may increase a speed of the training and/or a speed of satisfying the operation objectives through execution of the commands by the devices.

By implementing the management system as described herein, the management system coordinates operation of the devices of the target system to fulfill the operation objectives regardless of whether the devices originate from different manufacturers and/or accept different inputs. As a result, performance of the target system may be increased.

In some aspects, the techniques described herein relate to a system, including: at least one memory storing instructions thereon; and at least one processor configured to execute the instructions to: determine operation objectives for a target system; determine one or more devices of the target system to be controlled based on the operation objectives; generate, using a machine-learning model trained on data received from the target system, commands for the one or more devices based on the operation objectives; and communicate the commands to the target system to control the one or more devices based on the operation objectives.

In some aspects, the techniques described herein relate to a system, wherein the machine-learning model is trained to process natural language input, determine the operation objectives from the natural language input, and determine the one or more devices of the target system to be controlled based on the operation objectives.

In some aspects, the techniques described herein relate to a system, wherein the at least one processor is configured to: determine one or more external devices outside of the target system based on historical operation data of the target system describing interactions between the one or more external devices and the one or more devices of the target system; and generate the commands for the one or more devices further based on the interactions described by the historical operation data.

In some aspects, the techniques described herein relate to a system, wherein the at least one processor is configured to determine constraints of the one or more devices from the data and generate the commands further based on the constraints.

In some aspects, the techniques described herein relate to a system, wherein the data includes sensor data of the one or more devices.

In some aspects, the techniques described herein relate to a system, wherein the at least one processor is configured to: receive operational data from the target system following communication of the commands to the target system; determine whether the operation objectives are satisfied based on the operational data; and responsive to the operation objectives not being satisfied: generate, using the machine-learning model, updated commands based on the operational data; and communicate the updated commands to the target system.

In some aspects, the techniques described herein relate to a system, wherein the operation objectives specify at least one target condition for the target system, and the commands include instructions executable by the one or more devices to cause the one or more devices to adjust a condition of the target system to satisfy the at least one target condition.

In some aspects, the techniques described herein relate to a system, wherein each device of the one or more devices includes a respective application, and the at least one processor is configured to communicate the commands to the target system to control the one or more devices based on the operation objectives by communicating the commands to each respective application.

In some aspects, the techniques described herein relate to a system, wherein each application is encoded with a respective application programming interface (API), and the machine-learning model determines the commands based on each API.

In some aspects, the techniques described herein relate to a system, wherein the data describes one or more applications associated with the one or more devices and configured to execute instructions to cause the one or more devices to perform operations specified by the instructions.

In some aspects, the techniques described herein relate to a system, wherein the at least one processor is configured to generate one or more simulated applications, with each simulated application corresponding to a respective application of the one or more applications associated with the one or more devices.

In some aspects, the techniques described herein relate to a system, wherein the data includes application programming interface (API) data of the one or more applications and constraint data of the one or more applications; and the at least one processor is configured to: generate one or more simulated applications using the API data and the constraint data, the one or more simulated applications based on the one or more applications associated with the one or more devices; generate simulated commands including instructions to be executed by the one or more simulated applications; and train the machine-learning model using outcomes resulting from execution of the instructions of the simulated commands by the one or more simulated applications to generate the commands for the one or more devices.

In some aspects, the techniques described herein relate to a system, wherein the data includes historical operation data of the target system describing outcomes resulting from execution of instructions by the one or more applications; and the at least one processor is configured to: generate one or more simulated applications using the historical operation data, the one or more simulated applications based on the one or more applications associated with the one or more devices; generate simulated commands including instructions to be executed by the one or more simulated applications; and train the machine-learning model using outcomes resulting from execution of the instructions of the simulated commands by the one or more simulated applications to generate the commands for the one or more devices.

In some aspects, the techniques described herein relate to a system, further including maintaining a log in the at least one memory including data describing the commands communicated to the target system; and the at least one processor is configured to: receive user input for updating the log, the user input specifying adjustments to the commands; generate updated commands based on the adjustments using the machine-learning model; and communicate the updated commands to the target system.

In some aspects, the techniques described herein relate to a non-transitory computer-readable storage medium including instructions stored thereon that when executed by one or more processors, causes the one or more processors to: determine operation objectives for a target system; determine one or more devices of the target system to be controlled based on the operation objectives; generate, using a machine-learning model trained on data received from the target system, commands for the one or more devices based on the operation objectives; and control operation of the one or more devices based on the operation objectives by communicating the commands to the one or more devices.

In some aspects, the techniques described herein relate to a non-transitory computer-readable storage medium, wherein the instructions cause the one or more processors to determine constraints of the one or more devices and a respective application programming interface (API) associated with each device.

In some aspects, the techniques described herein relate to a non-transitory computer-readable storage medium, wherein the instructions cause the one or more processors to determine the operation objectives from natural language input using the machine-learning model.

In some aspects, the techniques described herein relate to a method, including: determining, by a computing device, operation objectives for a target system; determining, by the computing device, one or more devices of the target system to be controlled based on the operation objectives; generating, using a machine-learning model trained on data received from the target system, commands for the one or more devices based on the operation objectives; and controlling, by the computing device, operation of the one or more devices based on the operation objectives by communicating the commands to the one or more devices.

In some aspects, the techniques described herein relate to a method, wherein the operation objectives specify at least one target condition for the target system, and the commands include instructions executable by the one or more devices to cause the one or more devices to perform operations to adjust the target system to satisfy the at least one target condition.

In some aspects, the techniques described herein relate to a method, further including receiving natural language input via the computing device, and determining the operation objectives for the target system includes processing the natural language input via the machine-learning model.

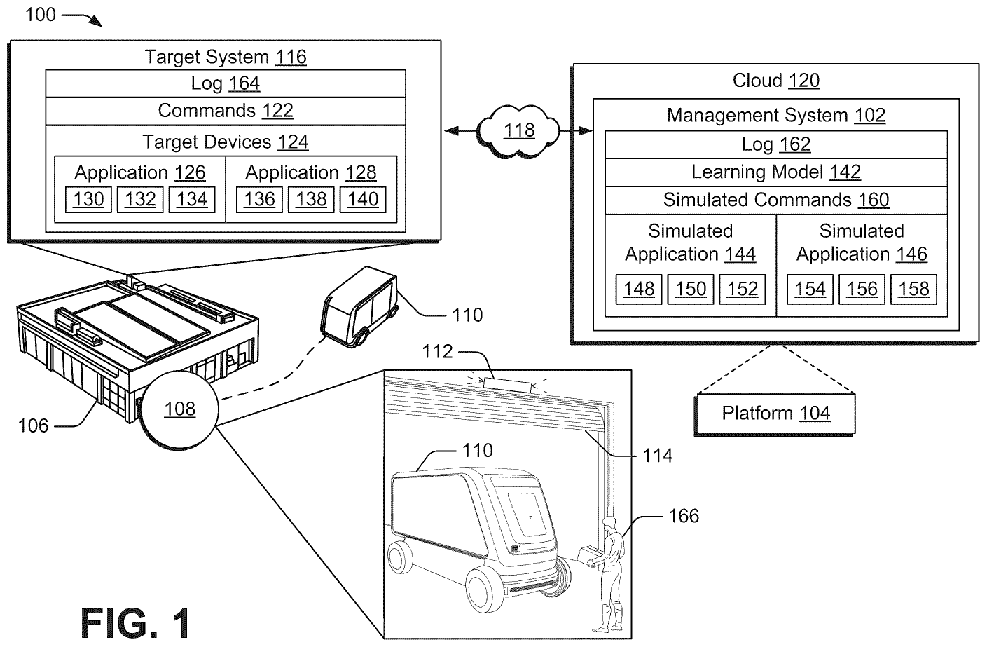

FIG. 1 illustrates a non-limiting example environment 100 which employs a management system 102 implementing a platform 104 for coordinated device operation. The environment 100 includes a facility 106 with an access point 108. In the depicted implementation, the facility 106 is a warehouse (e.g., a building or other structure used for storage and/or manufacture of items). However, it should be appreciated that the techniques described herein also apply to other environments that may include different types of structures, devices, etc. For example, the described techniques may be applied in environments including devices for automotive servicing and/or maintenance, construction, mining, recreational activities, culinary activities, airports, commercial retail spaces, etc.

A vehicle 110 is depicted that may travel to the facility 106. As one example, the vehicle 110 may travel to the access point 108 for loading and/or unloading of equipment, storage of the vehicle 110, etc. The vehicle 110 may be an autonomous vehicle, semi-autonomous vehicle, or manually operated vehicle in some examples. The vehicle 110 may be configured in a variety of different ways without departing from the techniques described herein.

The facility 106 includes various devices that maintain and/or adjust a condition of the facility 106, such as an illumination device 112 and a powered door 114 depicted at the access point 108. The various devices are included as part of a target system 116 that supports operation of the facility 106. In the depicted implementation, the target system 116 includes the aforementioned devices, the facility 106 itself, and the physical space defined by the facility 106. For example, the facility 106 may include various structures such as walls, fences, doors, ceilings, floors, etc., and the structures may form boundaries that define the space occupied by the facility 106. In some implementations, the target system 116 includes interior spaces of the facility 106 enclosed by exterior walls (e.g., the interior space of one or more buildings of the facility 106) and may additionally or alternatively include exterior spaces of the facility 106. Such exterior spaces may have perimeters or other boundaries defined by structures such as fences, retaining walls, or other landscape features. In some instances, the exterior spaces may be defined by property lines.

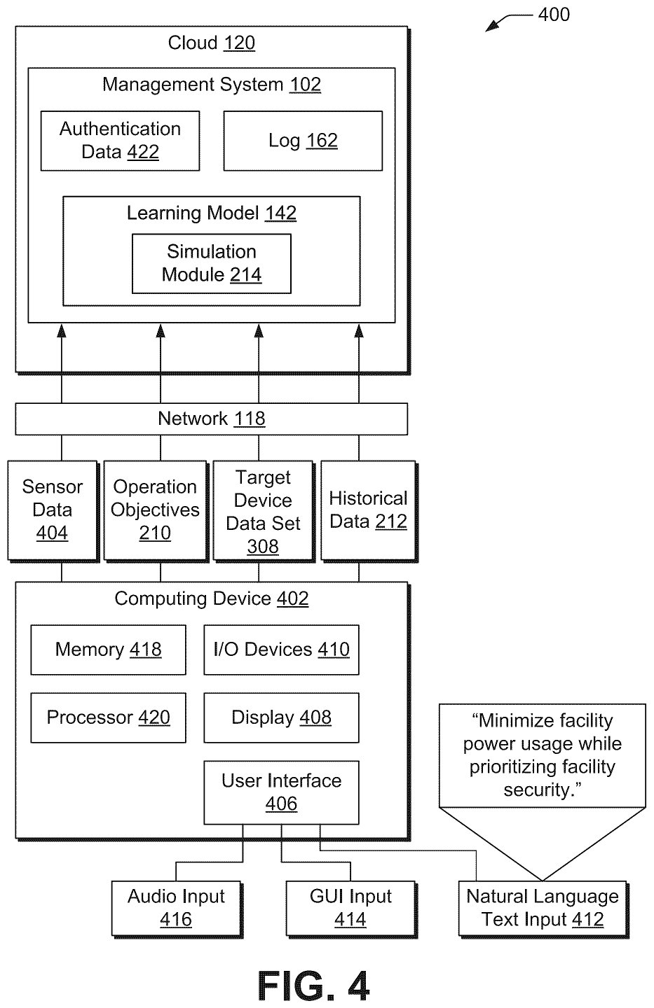

The target system 116 may thus include devices within the interior spaces and/or exterior spaces of the facility 106 and may additionally include the spaces that house the devices. Accordingly, parameters associated with the interior spaces and exterior spaces such as ambient air temperature, humidity, air particulate level, noise level, illumination level, number of occupants, etc. may be considered parameters of the target system 116. Such parameters may be tracked by the devices of the target system 116 and/or a computing device in electronic communication with the devices, such as a computing device 402 described below with reference to FIG. 4. The parameters of the target system 116 may further include parameters associated with operation of the devices and/or other components of the target system 116, such as usage of consumables (e.g., electrical power consumption, natural gas consumption, water consumption, etc.), energization durations (e.g., an amount of time in which a device is powered on), wear levels, etc.

In some implementations, the target system 116 may additionally and/or alternatively be defined by connections between devices within a group of devices (e.g., devices within the interior space and/or exterior space of the facility 106). As one example, a group of devices may include a first device and a second device, where the first device is a motion detector, camera, or other device configured to detect the presence of an individual or obstacle at a location, and the second device is an automatic powered door configured to open or close a doorway or other opening. The first device and the second device may be in electronic communication with each other such that actuation of the second device may occur responsive to communication of signals (e.g., wired or wireless electronic signals) from the first device to the second device. However, the first device and the second device may be arranged at separate locations (e.g., separated from each other by a distance such as fifty meters, one-hundred meters, etc.) without departing from inclusion of the first device and the second device within the target system 116.

Some of the devices of the target system 116 may be configured for electronic communication with other devices via a network 118. The network 118 may be a wired or wireless communication network. In some implementations, the network 118 may be the internet.

The management system 102 is depicted as integrated with a cloud service, referred to generally as a cloud 120. The management system 102 is employed for controlling operations of the target system 116 as described herein. In particular, the management system 102 is employed to communicate commands 122 to one or more target devices 124, where the target devices 124 are selected from the devices included by the target system 116.

The cloud 120 implementing the management system 102 in the depicted example is a distributed computing service accessible via the network 118. In some implementations, the management system 102 is implemented locally (e.g., via one or more computing devices within the facility 106). Implementing the management system 102 via the cloud 120 may increase a computational power available to the management system 102 by way of the multiple computing devices of the distributed computing service.

The platform 104 implemented by the management system 102 is accessible over the network 118. In the depicted implementation, the platform 104 is accessible via the cloud 120. The platform 104 is configured to receive user input for adjustment of operation of the management system 102 via a user interface, such as a webpage.

The management system 102 is configured to manage the target system 116 and coordinate operation of the target devices 124 of the target system 116. In implementations, the target devices 124 may be devices that are housed within and/or integrated with the facility 106 to support operation of the facility 106. For example, the target devices 124 may be security cameras, locks, doors, gates, lights, speakers, air conditioning equipment, heating equipment, alarms, powered windows, etc. installed to the facility 106 (e.g., within an interior or exterior of the facility 106).

The management system 102 may further identify devices external to the target system 116, such as the vehicle 110 that resides outside of the boundaries of the facility 106 and travels temporarily to the facility 106. The commands 122 communicated to the target devices 124 by the management system 102 may account for the temporary presence of such external devices. For example, although the vehicle 110 may be classified as an external device by the management system 102, the operation of the powered door 114 and illumination device 112 as controlled by the management system 102 may include the commands 122 to be executed by the target devices 124 during conditions in which the vehicle 110 is present at the access point 108.

Each of the target devices 124 is electronically operable via wired and/or wireless connections. Wired connections may include, for example, connections via Ethernet cables. Wireless connections may include, for example, connections using Wi-Fi, ultra-wideband, Bluetooth®, etc. In some implementations, one or more of the target devices 124 communicate electronically over the network 118 directly with the management system 102. In some implementations, one or more of the target devices 124 communicate with one or more computing devices separate from the cloud 120 (e.g., computing devices housed within the facility 106), and the one or more computing devices communicate electronically with the management system 102 on behalf of the target devices 124 to facilitate control of the target devices 124 via the management system 102 according to the techniques described herein.

The target devices 124 may be configured in a variety of different ways and may support different operations. For example, some devices may have binary modes of operation (e.g., adjustable between an “on” mode and an “off” mode). Some devices may have more than two modes of operation (e.g., an “open” mode, a “closed” mode, and one or more “partially opened” modes). Some devices may include a respective controller that can cause the device to execute pre-determined routines (e.g., operating in an “on” mode for a specified duration and switching to an “off” mode thereafter).

To facilitate electronic operation of the target devices 124, each of the target devices 124 may be driven by a corresponding application (e.g., software). As an example, a first device of the target devices 124, such as the illumination device 112, may be driven by an application 126, and a second device, such as the powered door 114, may be driven by an application 128. In this example, the application 126 may cause the illumination device 112 to perform different functions such as a first function 130, a second function 132, or a third function 134. The functions may include, for example, different lighting patterns, illumination output amounts, etc. The application 128 may cause the powered door 114 to perform different functions such as a first function 136, a second function 138, or a third function 140, which may correspond to fully opening, fully closing, or partially opening, respectively.

In some implementations, the applications are integrated directly with the target devices 124 (e.g., stored in memory at the target devices 124). In some implementations, the applications are stored remotely (e.g., in a memory of one or more computing devices) and communicate electronically with the target devices 124 over the network 118. For example, the illumination device 112 may include a lighting controller as an integrated circuit, and the controller may include a memory, processor, and/or other components for adjusting the illumination output of the illumination source. The memory of the controller may include the application which is executable by the processor to control the illumination output of the illumination source, for example.

Each application (e.g., application 126 and application 128) may include a respective application programming interface (API). The API of an application describes inputs that can be provided to the application and types of data that can be retrieved from the application. The management system 102 may receive API data (e.g., API documentation) describing the APIs of each application associated with the target devices 124 over the network 118. The management system 102 may process the API data to generate the commands 122 that can be executed by the target devices 124 (e.g., commands that are readable by the applications of the target devices 124).

The management system 102 includes a machine-learning model 142 configured to generate the commands 122 that are communicated to the target devices 124. The machine-learning model 142 may generate the commands 122 based on the API data of the target devices 124. In an example, the target devices 124 may include a pair of devices of a similar type, such as two illumination devices. However, the illumination devices may have different manufacturers. Thus, commands readable and executable by one of the pair of devices may not be readable or executable by the other device of the pair. However, by generating the commands 122 based on the API data using the machine-learning model 142, each device is able to read and execute the commands 122 even if the other target devices 124 are not identical.

The commands 122 are generated based on operation objectives. In some implementations, the operation objectives are provided as user input to the platform 104. The operation objectives may be input as plain language descriptions of objectives to be met for the target system 116, as described further below.

In some implementations, the management system 102 is configured to virtually simulate outcomes of operation of the target devices 124 for training the machine-learning model 142. To do so, the management system 102 receives data describing constraints of the target devices 124, as well as the API data described above. Based on the received data, the management system 102 performs virtual simulations that are representative of real-life operation of the target devices 124 under various conditions. The virtual simulations may include simulated applications employed by the management system 102 that are based on the applications of the target devices 124 using the API data. For example, the management system 102 is depicted including a first simulated application 144 and a second simulated application 146. The simulated application 144 may be based on the application 126, and the simulated application 146 may be based on the application 128.

The management system 102 employs the API data of the target devices 124 and the constraint data to configure the simulated applications. The simulated applications are configured to simulate the behavior of the applications of the corresponding real-world target devices within the virtual simulation environment of the management system 102. For example, the simulated application 144 is configured to virtually simulate a first function 148, a second function 150, and/or a third function 152 in the virtual simulations, corresponding to the first function 130, second function 132, and third function 134, respectively, associated with the application 126. The simulated application 146 is configured to virtually simulate a first function 154, a second function 156, and a third function 158 in the virtual simulations, corresponding to the first function 136, second function 138, and third function 140, respectively, associated with the application 128. The virtual simulations as described herein refer to simulations performed within the virtual environment of the management system 102, e.g., simulations performed using memory and processors of one or more computing devices implementing the management system 102.

Further, the simulated applications are configured to receive simulated inputs corresponding to the inputs received by the corresponding applications of the real-world target devices 124. For example, the application 126 may be configured to receive a first type of input (e.g., an electronic signal having a particular format readable by the application 126) that causes the application 126 to actuate the target device including the application 126 to perform the first function 130. The simulated application 144 is configured to receive simulated input that mimics the first type of input, with the simulated input causing the simulated application 144 to perform the first function 154 in the virtual simulation environment.

In implementations, the management system 102 generates the commands 122 based on simulated commands 160. For example, outcomes that result from providing the simulated commands 160 to the simulated applications may be utilized by the machine-learning model 142 to generate the commands 122. The outcomes may describe, for example, simulated conditions of the target system 116 resulting from the functions performed by the simulated applications. This may increase a reliability and/or speed of satisfying the operation objectives through operation of the target devices 124, as the outcomes of communicating the commands to the target devices 124 may closely match the outcomes of communicating the simulated commands 160 to the simulated applications. However, in some implementations, the management system 102 generates the commands 122 using the machine-learning model 142 without performing the virtual simulation of operation of the target devices 124. For example, the machine-learning model 142 may be trained on real-world outcomes that result from communicating commands to the target devices 124.

In the depicted implementation, the management system 102 includes a log 162. The log 162 may include historical data describing sequences of the simulated commands 160 that have been performed, outcomes of the simulated commands 160, etc. The log 162 may provide an indication of whether the operation objectives are satisfied within the virtual simulation environment of the management system 102 responsive to providing the simulated commands 160 to the simulated applications. If the simulated commands 160 do not result in fulfillment of the operation objectives, the log 162 may indicate the ways in which the operation objectives were not fulfilled, a degree to which the objectives were not fulfilled, etc.

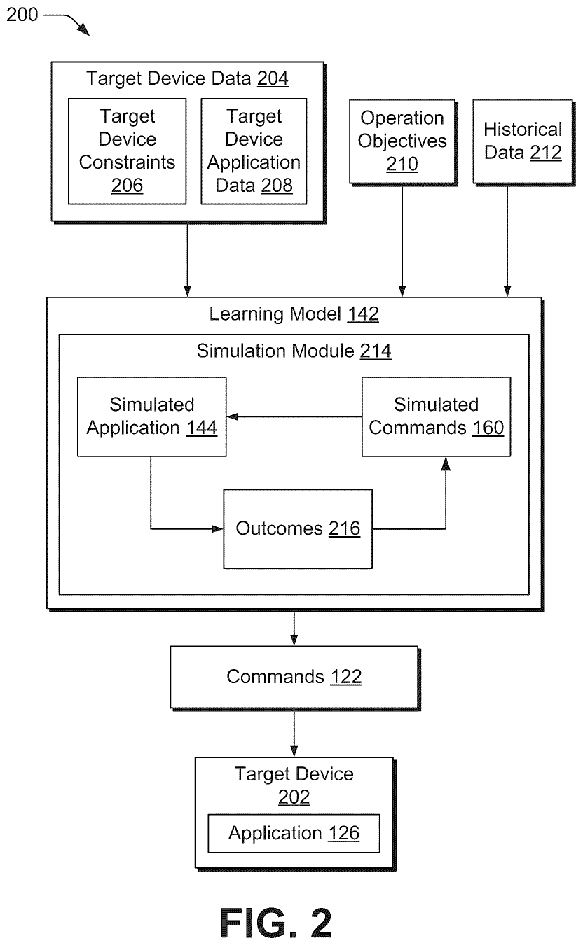

Further, in the depicted implementation, the target system 116 includes a log 164. The log 164 may include historical data (depicted by FIG. 2) describing operations performed by the target devices 124. The historical data may further describe outcomes resulting from execution of instructions included in the commands 122 by the applications of the target devices 124. Such outcomes may include, for example, conditions of the target system 116 resulting from the execution of the commands 122 by the target devices 124 (e.g., air temperature, power usage, etc.). In some implementations, the log 164 includes historical data describing the commands 122 communicated to the target devices 124. For example, the historical data in the log 164 may indicate whether the commands 122 communicated to the target devices 124 were successfully performed by the target devices 124.

FIG. 2 is a block diagram of a non-limiting example 200 of generation of the commands 122 for the target system 116 via the platform 104 for coordinated device operation. In the depicted example, the machine-learning model 142 receives various inputs (e.g., data), and the machine-learning model 142 outputs commands 122 to be communicated to a target device 202 based on the inputs. The target device 202 is one of the target devices 124 of the target system 116 described above (e.g., a door, a light, an air conditioner, a heater, etc.).

As used herein, the term “machine-learning model” refers to a computer representation that is tunable (e.g., through training and retraining) based on inputs without being actively programmed by a user to approximate unknown functions, automatically and without user intervention. A machine-learning model, such as the machine-learning model 142, may be a multi-modal model utilizing networks and algorithms to learn from, and make predictions on, known data by analyzing training data to learn and relearn to generate outputs that reflect patterns and attributes of the training data. For example, the machine-learning model 142 may employ one or more neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc. for performing the techniques described herein. The machine-learning model 142 may implement one or more large language models (LLMs) capable of interpreting natural language input by employing the networks and algorithms, such as one or more of the example networks and algorithms described above. The machine-learning model 142 executes on one or more processors, such as one or more processors implementing the cloud 120 as described further below.

In the depicted implementation, the machine-learning model 142 receives target device data 204. The target device data 204 includes data describing target device constraints 206. The target device constraints 206 describe information about the target device 202 such as ranges of operation (e.g., minimum and maximum opened or closed positions of doors, minimum and maximum illumination levels of lights, etc.), operation modes, energization levels, etc. The target device data 204 additionally includes target device application data 208. The target device application data 208 includes the API data described above.

The machine-learning model 142 additionally receives data describing operation objectives 210. In some implementations, the operation objectives 210 are input via the platform 104. The operation objectives 210 may be input as natural language instructions describing one or more target conditions of the target system 116 to be satisfied. For example, the operation objectives 210 may specify target conditions such as “minimize facility power usage while prioritizing facility security,” “increase device automation and reduce human interaction,” “maximize revenue generated by the facility,” “prioritize device longevity and reliability,” “prioritize reproducibility of device operation,” “control power usage while focusing on decreasing time to complete tasks,” “grant entry to authorized individuals and vehicles unless unauthorized individuals or vehicles are present or approaching,” “authorize vehicles for entry that have verified payloads unless the payloads have changed weight, contents, or appearance since the most recent verification,” “verify route information of approaching vehicles and prevent vehicles that have traveled farther than one kilometer from the facility within the last week from entering,” etc.

The machine-learning model 142 may be trained on natural language data describing various objectives and may process natural language content of the operation objectives to determine which of the target devices 124 will receive commands (e.g., the target device 202) to be executed to satisfy the input operation objectives 210. For example, the operation objectives may include natural language content describing one or more target conditions, such as to “minimize facility power usage while prioritizing facility security.” Responsive to processing the operation objectives 210, the machine-learning model 142 may determine one or more target devices to be controlled based on the content of the operation objectives 210 (e.g., the target conditions described by the natural language content). To do so, the machine-learning model 142 may identify parameters to be maintained or adjusted from the operation objectives 210, such as “power usage” and “facility security.” The machine-learning model 142 may further identify devices associated with those parameters, such as the powered door 114. Identifying the devices associated with the parameters may be performed by the machine-learning model 142 based on associations of the devices with the parameters described by the historical data 212, for example.

In the above example, the machine-learning model 142 may determine that the powered door 114 may be controlled to satisfy the operation objectives 210. The machine-learning model 142 may thus designate the powered door 114 as the target device 202 and may generate commands 122 for controlling operation of the powered door 114. As an example, the commands 122, when executed by the powered door 114 (e.g., via an application associated with the powered door 114, such as application 128), may increase a duration in which the powered door 114 is maintained open to reduce electrical power usage associated with opening and closing the powered door 114. Concurrently, execution of the commands 122 may realize increased security of the facility 106 to satisfy the instruction of “prioritizing facility security” by closing the powered door 114 if a user (e.g., user 166) that is not authorized to enter the facility 106 is detected proximate to the powered door 114 (e.g., via a camera using facial recognition or other type of recognition of authorized individuals and unauthorized individuals), even if the closing of the powered door 114 results in some consumption of electrical power.

The commands 122 generated by the machine-learning model 142 may be based on the constraint data of the target devices 124, such as the target device constraints 206. For example, the target device constraints 206 may describe a speed and/or range of opening and/or closing of the target device 202 (e.g., the powered door 114). The commands 122 generated by the machine-learning model 142 may account for such constraints. As a result, execution of the commands 122 by the target device 202 causes the target device 202 to operate in a manner that satisfies the operation objectives 210.

In some implementations, the machine-learning model 142 receives historical data 212 describing historical operation of the target system 116. The historical data 212 may include time-series data from the log 164 describing various parameters and conditions of the target system 116 over a duration (e.g., one week, one month, etc.). In some implementations, the historical data 212 includes sensor data 404 output by one or more sensors of the target system 116 (depicted by FIG. 4).

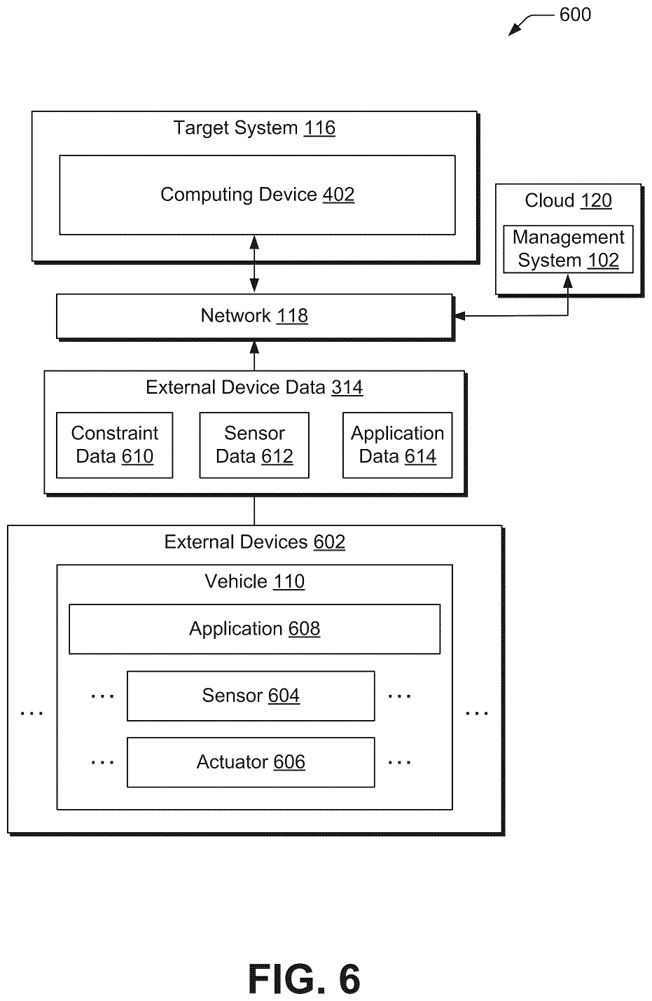

The historical data 212 may further include data describing interactions between the devices of the target system 116 (e.g., target devices 124) and devices external to the target system 116 (e.g., external devices as described below with reference to FIG. 6). The interactions may include, for example, detection of the approach and/or presence of the vehicle 110 or another external device by one or more motion detectors or position detectors of the target system 116, communication of credentials or other authentication information from the vehicle 110 or another external device to one or more authentication devices of the target system 116, detection of illumination output by the vehicle 110 via one or more illumination detectors of the target system 116, etc.

The machine-learning model 142 may be trained using the historical data 212 such that the machine-learning model 142 is able to predict conditions of the target system 116 that result from operation of the target devices 124 and/or interactions between the target devices 124 and external devices. For example, the machine-learning model 142 may be trained using the historical data 212 to predict a temperature of ambient air within the facility 106 that results from operating an air conditioning device at particular energization levels for various durations. As another example, the machine-learning model 142 may be trained using the historical data 212 to predict ways in which changes to an overall energy usage of the facility 106 result in changes to revenue generation of the facility 106, along with identifying which devices are associated with such changes. As yet another example, the machine-learning model 142 may be trained using the historical data 212 to predict the behavior of the external devices and ways in which the external devices may interact with the target devices 124 (e.g., predictions of a location, speed, delivery load amount and/or contents, passenger identity, etc. of the vehicle 110). Other examples are possible.

In the depicted implementation, the machine-learning model 142 receives the various data described above and utilizes the data to perform virtual simulations of the devices of the target system 116 via a simulation module 214. The simulation module 214 simulates operation of the target system 116 as described above. To do so, the simulation module 214 generates simulated commands 160 that are performed by simulated applications, such as the simulated application 144. The simulated applications generate outcomes 216 that describe conditions of the simulated version of the target system 116 that results from the simulated applications performing the simulated commands 160. The outcomes 216 may describe, for example, power usage, revenue generation, reproducibility of device operation, security levels or ratings, etc.

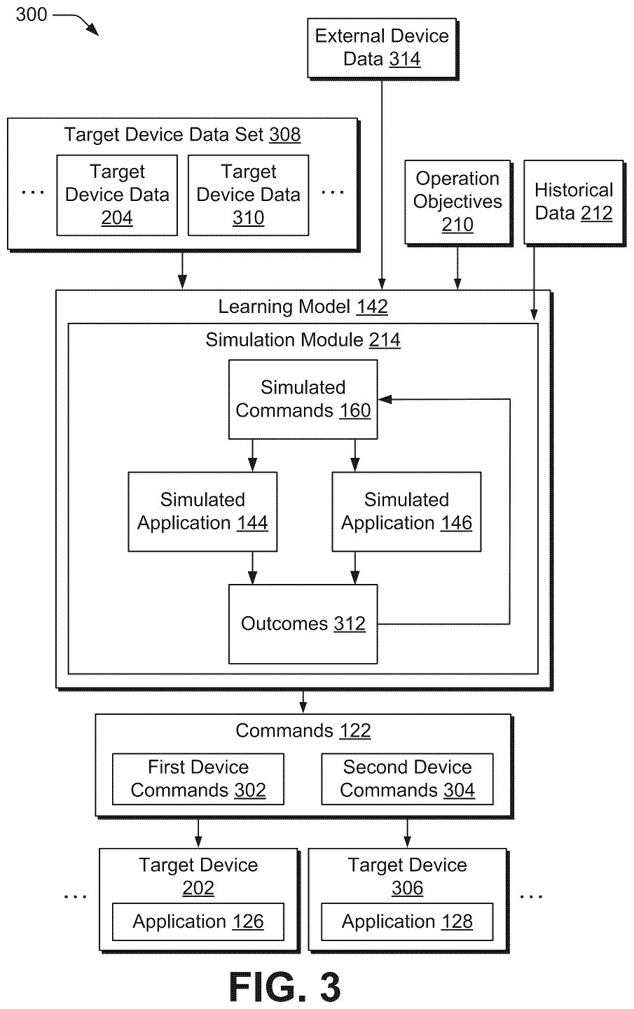

In this example, the simulation module 214 employs the simulated application 144 and outputs commands 122 for the target device 202. In other implementations, such as the implementation depicted by FIG. 3 and described below, the simulation module 214 may employ multiple simulated applications and may output commands for multiple target devices. The commands 122 output by the machine-learning model 142 are communicated electronically to the target device 202. For example, the commands 122 are communicated over the network 118. In some implementations, the management system 102 electronically communicates the commands 122 to a computing device (e.g., computing device 402 described below with reference to FIG. 4), and the computing device electronically communicates the commands 122 to the target device 202.

The devices of the target system 116 execute the commands 122 in order to satisfy the operation objectives 210 according to the described techniques. In the example described above, the commands 122 are executed by the application 126 of the target device 202, with the resulting operation of the target device 202 directed toward satisfying the operation objectives 210. Satisfying the operation objectives 210 may include performing operations via the target devices 124 that adjust condition of the target system 116 to match a target condition specified by the operation objectives. The target condition may be based on various thresholds and/or ranges as described below.

In some examples, the operation objectives 210 specify particular thresholds, and operation of the target devices 124 is controlled using the commands 122 to adjust the condition of the target system 116 to satisfy the thresholds. In an example, the operation objectives 210 are received as natural language input that specifies instructions to “reduce door power usage by fifty percent while preserving entry access for authorized individuals.” In this scenario, the machine-learning model 142 may process the natural language input and set the target condition for the target system 116 as a condition in which the power usage of the door (e.g., the powered door 114) is below a threshold power usage.

The machine-learning model 142 may determine the threshold power usage based on recent power usage amounts associated with operation of the door (e.g., power usage amounts indicated in the historical data 212). For example, a most recent power usage associated with operation of the door may be equal to one-half kilowatt-hour per day. Based on the recent power usage and the content of the operation objectives 210 described above, the machine-learning model 142 may set the threshold power usage of the door equal to one-quarter kilowatt-hour per day. The machine-learning model 142 also determines the commands 122 to communicate to the target system 116 to control the operation of the door such that the power usage of the door is reduced below the threshold to satisfy the operation objectives 210. The machine-learning model 142 determines the commands 122 to concurrently satisfy the condition of “preserving entry access for authorized individuals.” For example, the commands 122 may reduce an amount of opening of the door (e.g., vertical clearance through the opened door) and/or a number of opening cycles of the door to concurrently satisfy the conditions of reducing the door power usage below the threshold while not preventing authorized individuals from entering the facility 106 through the door.

In some situations, the natural language input of the operation objectives 210 may not specify particular thresholds, and the machine-learning model 142 may determine appropriate thresholds or ranges by interpreting the content of the natural language input. For example, the operation objectives 210 may include natural language input that specifies instructions to “reduce door power usage while preserving entry access for authorized individuals,” without specifying a threshold or range for the reduction of the power usage. In the example in which the door is the target device 202, the machine-learning model 142 may determine a threshold or range of power usage of the door based on the historical data 212 and the target device constraints 206. To do so, the machine-learning model 142 may determine an average power usage of the door based on the historical data 212, for example, and perform simulations via the simulation module 214 to determine amounts by which the power usage may be reduced responsive to execution of the simulated commands 160 by the simulated application 144.

For example, the machine-learning model 142 may determine that a first set of commands may reduce the power usage to eighty percent of the average power usage, a second set of commands may reduce the power usage to sixty percent of the average power usage, and a third set of commands may reduce the power usage to forty percent of the average power usage. However, the third set of commands may cause the door to operate in a manner that interferes with the target condition of “preserving entry access for authorized individuals,” while the second set of commands does not cause the interference. Accordingly, the machine-learning model 142 may select the second set of commands to be communicated as the commands 122 to the target device 202, and the power usage threshold used to determine whether the operation objectives 210 have been satisfied may be set to equal sixty percent of the determined average power usage. In some implementations, the machine-learning model 142 may be configured to recognize particular phrases and associate the particular phrases with particular amounts of adjustment (e.g., reducing power usage by “a lot” may be recognized as a reduction of more than fifty percent, reducing power usage by “a little” may be recognized as a reduction of less than twenty percent, etc.).

FIG. 3 is a block diagram of another non-limiting example 300 of generation of the commands 122 for the target system 116 via the platform 104 for coordinated device operation. In the depicted implementation, the machine-learning model 142 receives various data and outputs commands 122 to multiple target devices. In particular, the commands 122 include operations 302 to be communicated to the target device 202 and operations 304 to be communicated to a target device 306.

The machine-learning model 142 receives target device data for the multiple target devices. The target device data for the target devices is represented collectively by a target device data set 308. However, it should be appreciated that the machine-learning model 142 may receive the target device data for one or more target devices separately from target device data of other target devices. For example, in the depicted implementation, the target device data set 308 includes target device data 204 associated with the target device 202 and target device data 310 associated with the target device 306. The target device data 310 may describe constraints, application data, etc. associated with the target device 306. In some implementations, the target device data 204 may be received by the machine-learning model 142 separately from the target device data 310. The target device 202 and the target device 306 are each devices included in the target devices 124 described above. The target device 202 may be the powered door 114 for example, and the target device 306 may be the illumination device 112 for example.

In the depicted implementation, the simulation module 214 employs multiple simulated applications for training of the machine-learning model 142. In particular, the simulation module 214 employs the simulated application 144 and the simulated application 146. The simulated application 144 and the simulated application 146 each correspond to real-world target devices (e.g., target device 202 and target device 306, respectively). The simulated applications generate outcomes 312, and the machine-learning model 142 determines whether the outcomes 312 satisfy the operation objectives 210 within the virtual environment. If the operation objectives 210 are not satisfied, the simulation module 214 generates an updated version of the simulated commands 160 based on the outcomes 312 and provides the updated version of the simulated commands 160 to the simulated application 144 and simulated application 146 to generate an updated version of the outcomes 312. This process may continue until the operation objectives 210 are satisfied within the virtual environment.

In the depicted implementation, the machine-learning model 142 additionally receives external device data 314. The external device data 314 describes one or more devices external to the target system 116, such as the vehicle 110. The external device data 314 additionally describes various characteristics associated with the one or more external devices. For example, the external device data 314 may describe physical characteristics of vehicle 110 (e.g., height, weight, etc.), operating characteristics of the vehicle 110 (e.g., vehicle speed capabilities, load capabilities, towing capabilities, etc.), and/or other characteristics. The external device data 314 may be received from the one or more external devices in some implementations. Additionally or alternatively, the external device data 314 may be stored in the cloud 120 and may be retrieved from the cloud 120.

In some implementations, the management system 102 electronically communicates the commands 122 to a computing device (e.g., the computing device 402 described below with reference to FIG. 4), and the computing device electronically communicates the commands 122 to the target device 202 and the target device 306.

In some implementations, the commands 122 are communicated to the target devices 124, and the target devices 124 execute the commands 122. The execution of the commands 122 and the outcomes resulting from the execution of the commands 122 (e.g., changes to conditions of the target system 116 such as power usage, air temperature, etc.) update the historical data 212 in the log 164. The target system 116 may communicate the updated historical data to the management system 102, and responsive to the outcomes described in the updated historical data, the machine-learning model 142 may generate updated commands to be communicated to the target system 116. This process may repeat such that the commands are updated to cause the operation objectives 210 to be satisfied through the operation of the target devices 124.

FIG. 4 is a block diagram of a non-limiting example 400 of the computing device 402 in electronic communication with the management system 102 implementing the platform 104 for coordinated device operation. In the depicted implementation, the computing device 402 communicates electronically with the management system 102 over the network 118. The computing device 402 may be implemented as a personal computer, laptop, tablet, or other type of computing device. In some implementations, the computing device 402 may be housed within the facility 106. In other implementations, the computing device 402 may be remote from the facility 106 (e.g., located outside of the facility 106).

In the implementation shown, the computing device 402 receives data from the target devices 124 and communicates data associated with the target devices 124 to the management system 102. For example, one or more of the target devices 124 may be in electronic communication with the computing device 402 via a wired connection (e.g., an Ethernet cable) or a wireless connection (e.g., Wi-Fi). The computing device 402 receives data from the target devices 124 (such as the target device data 204) and communicates the data to the management system 102. The computing device 402 thus may receive data from the target devices 124 and manages communication of the data to the management system 102. In some implementations, the target devices 124 may additionally and/or alternatively communicate the data over the network 118 directly to the management system 102 (e.g., bypassing the communication of the data to the computing device 402).

The computing device 402 may communicate electronically with the management system 102 via the platform 104 implemented by the management system 102. As an example, a user interface 406 may be employed by the computing device 402 to receive user input. The user interface 406 may be implemented as a web browser or other computer application configured to receive information from the management system 102 via the platform 104 and display the information via a display 408. In some implementations, the platform 104 is configured as a website that is accessible by the computing device 402 using the user interface 406.

The user interface 406 may receive user input applied via one or more input/output (I/O) devices 410. The I/O devices 410 may include, for example, a mouse, trackpad, keyboard, touchscreen, microphone, camera, or other type of user input device. The user input may include natural language text input 412, graphical user interface (GUI) input 414, and/or audio input 416. The natural language text input 412 may include natural language descriptions (e.g., descriptions in plain, conversational English) of target conditions included in the operation objectives 210, for example. The GUI input 414 may include inputs to a menu of the user interface 406 for selection of the operation objectives 210. The audio input 416 may include natural language input such as spoken words that are received via a microphone or other audio receiver device of the I/O devices 410, and the spoken words are processed by the computing device 402 using voice recognition techniques to convert the spoken words to text.

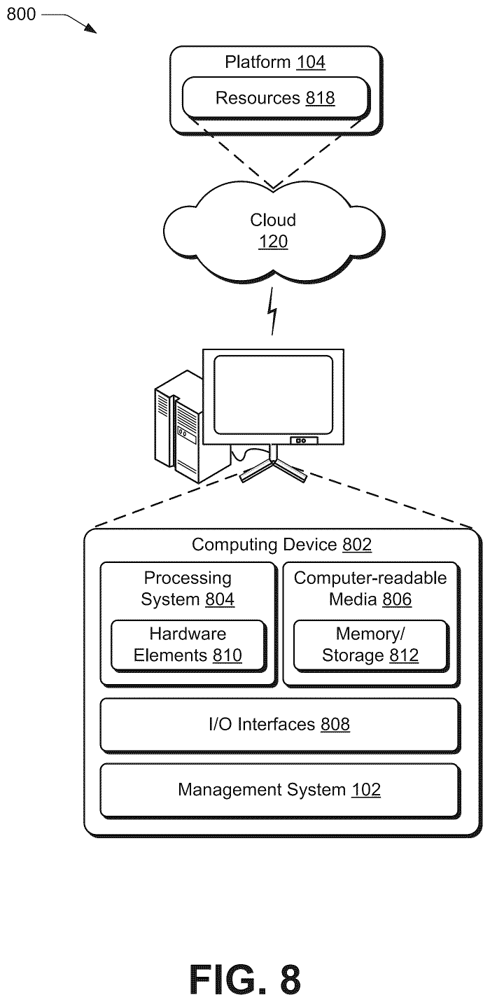

The computing device 402 includes a memory 418, a processor 420, I/O devices 410, a display 408, and a user interface 406. The memory 418, the processor 420, and the I/O devices 410 may be similar to a memory/storage 812, a processing system 804, and I/O interfaces 808, respectively, described further below with reference to FIG. 8. It should be appreciated that in some implementations the computing device 402 may include at least one additional memory and/or at least one additional processor. The display 408 may be a monitor, touchscreen, or other type of display device for output of the user interface 406.

The data communicated to the management system 102 may include sensor data 404 associated with one or more sensors of the target devices 124. The sensor data may include, for example, data describing historical outputs of the sensors (e.g., sensor measurements or output values over a duration), data describing various parameters measured by the sensors (e.g., temperature, pressure, etc.), data describing inputs to the sensors (e.g., electrical current, voltage, etc.), etc. In the implementation shown, the computing device 402 receives the sensor data 404 from the target devices 124 and communicates the sensor data 404 to the management system 102 over the network 118. The sensor data 404 may be used by the machine-learning model 142 for implementing the simulated commands 160 and simulated applications described above. The machine-learning model 142 may additionally or alternatively be trained using the sensor data 404, e.g., for generating the commands 122.

In some implementations, access to communicate input to the management system 102 via the user interface 406 is controlled using authentication data 422. The authentication data 422 may include credentials such as one or more usernames, passwords, and so forth used to prevent unauthorized access to the management system 102. For example, a user such as an administrator of the facility 106 may be associated with a corresponding username and password included in the authentication data 422. The management system 102 may be configured to compare credentials input via the user interface 406 to credentials stored in the authentication data 422. Responsive to determining a match between the input credentials and the credentials stored in the authentication data 422, the management system 102 may permit input of the operation objectives 210 and other information for adjusting of the operation of the management system 102. However, if the input credentials do not match the credentials stored in the authentication data 422, the management system 102 may deny the user access to prevent unauthorized adjustment of the operation of the management system 102.

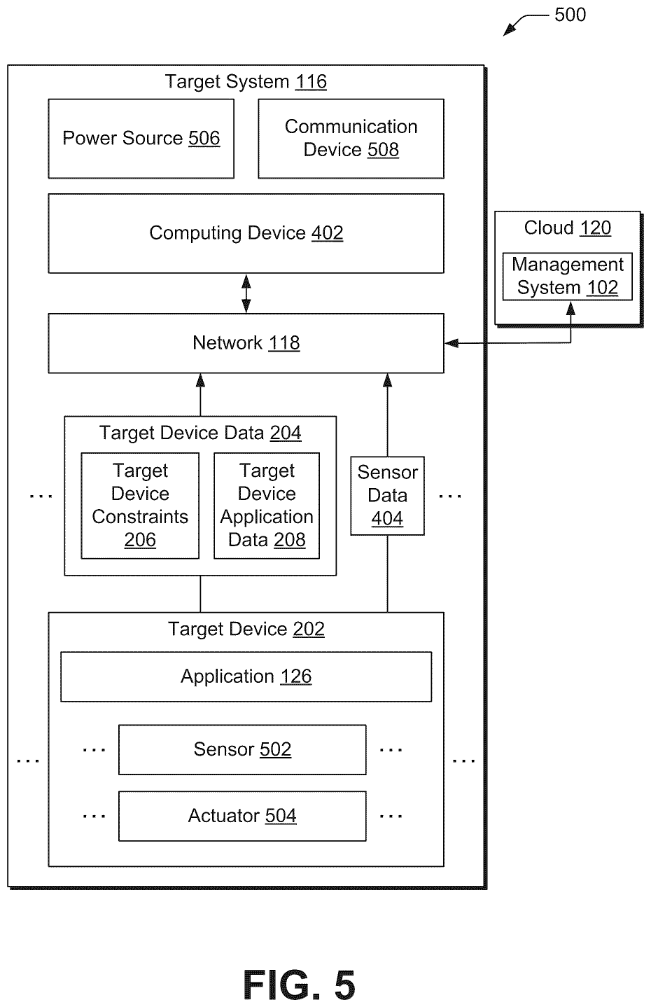

FIG. 5 is a block diagram of a non-limiting example 500 of the target system 116 in electronic communication with the management system 102 implementing the platform 104 for coordinated device operation. In the depicted implementation, the computing device 402 is in electronic communication with the target device 202 via the network 118. The target device 202 is depicted as including a sensor 502 and an actuator 504. The sensor 502 may be employed by the target device 202 for sensing one or more environmental conditions. As one example, the sensor 502 may detect (e.g., measure) conditions such as air temperature, motion, presence of a user or obstacle, ambient light, etc. The actuator 504 may be employed by the target device 202 to perform various actions that may include movement of one or more components of the target device 202. As one example, the target device 202 may be the powered door 114, and the actuator 504 may be employed to move the powered door 114 (e.g., extend or retract the powered door 114) to adjust an amount of opening of the powered door 114. As another example, the target device 202 may be the illumination device 112, and the actuator 504 may be employed for rotation of one or more illumination emitters within the illumination device 112.

The configuration of the sensor 502 and the actuator 504 may be described by the target device data 204. For example, the target device constraints 206 may describe constraints of the actuator 504 and the sensor 502, such as movement ranges of the actuator 504, detection ranges of the sensor 502, etc. Although the target device 202 is depicted as including the sensor 502 and the actuator 504, in some implementations the target device 202 may include one or more additional sensors and/or one or more additional actuators.

In the depicted implementation, the target system 116 includes a power source 506. The power source 506 may be a power source of the facility 106 and may provide power (e.g., electrical current) to the computing device 402 and one or more of the target devices 124. As one example, the power source 506 may be a utility electrical power source (e.g., part of an electrical grid infrastructure). Usage of electrical power supplied by the power source 506 may be tracked via one or more devices such as power meters, and data describing the tracked electrical usage may be communicated from the one or more devices to the computing device 402.

In the depicted implementation, the target system 116 includes a communication device 508. The communication device 508 may be a router, modem, or other type of communication device capable of wired and/or wireless electronic communication. For example, the communication device 508 may act as a communication gateway providing access to the network 118 to the computing device 402 and the target devices 124.

FIG. 6 is a block diagram of a non-limiting example 600 of external devices 602 in electronic communication with the management system 102 implementing the platform 104 for coordinated device operation. In the depicted implementation, the external devices 602 are in electronic communication with the computing device 402 over the network 118. The external devices 602 are devices external to the target system 116 and the facility 106. As one example, the external devices 602 may include the vehicle 110. Each of the external devices 602 may include one or more respective sensors and/or actuators. For example, the vehicle 110 is depicted as including a sensor 604 and an actuator 606. The sensor 604 may be one of various sensors on board the vehicle 110. For example, the sensor 604 may be a proximity sensor or other sensor configured to detect objects, individuals, or obstacles within a vicinity of the vehicle 110. Likewise, the actuator 606 may be one of various actuators on board the vehicle 110. For example, the actuator 606 may be an actuator for doors, windows, locks, brakes, or other components of the vehicle 110.

The external devices 602 may communicate data to the computing device 402 using the network 118. The data may describe, for example, operating conditions of the external devices 602, sensor data of the external devices 602, constraints of the external devices 602, etc. Further, the external devices 602 may include respective applications configured to support operation of the external devices 602.

For example, the vehicle 110 is depicted including an application 608. The application 608 may be stored in a memory of the vehicle 110 (e.g., non-transitory computer memory) and may be configured to receive data from the sensor 604 and control actuation of the actuator 606. In the depicted implementation, the vehicle 110 communicates constraint data 610, sensor data 612, and application data 614 to the computing device 402. The constraint data 610 describes constraints of the vehicle 110. The constraints of the vehicle 110 may include, for example, operation ranges associated with the actuator 606 (e.g., minimum and maximum movement amounts of the actuator 606, movement directions of the actuator 606, etc.). The sensor data 612 describes one or more parameters detected (e.g., sensed, measured, etc.) by the sensor 604, such as a distance and location of obstacles proximate to the vehicle 110, ambient light conditions, etc. The application data 614 describes characteristics of the application 608, such as an API associated with the application 608.

Upon receiving the data from the vehicle 110, the computing device 402 may communicate the data to the management system 102. The management system 102 may utilize the data communicated to the computing device 402 from the vehicle 110 for operations such as training of the machine-learning model 142, performing simulations via the simulation module 214, etc.

The vehicle 110 may include a vehicle network that operatively couples a plurality of vehicle subsystems to a control system of the vehicle. In at least one implementation, the vehicle 110 is operable to receive wired and/or wireless electronic communications from one or more devices, such as the computing device 402. Such communications may include requests for communication of constraint data 610, sensor data 612, application data 614, or other types of data from the vehicle 110 to the computing device 402. The control system may include one or more processors for processing instructions to execute control routines on the vehicle and manage vehicle operations implemented by devices on board the vehicle 110. The processors and connected devices may be electronically coupled to a memory (e.g., non-transitory semiconductor memory) of the vehicle 110 that stores instructions for execution by the processors to control the vehicle operations or implement vehicle functions in furtherance of the vehicle operations. In at least one implementation, at least some functionality of the vehicle 110 is implementable entirely or partially through use of a distributed system, such as the cloud 120 which utilizes computing systems and/or data maintained remotely from the vehicle 110.

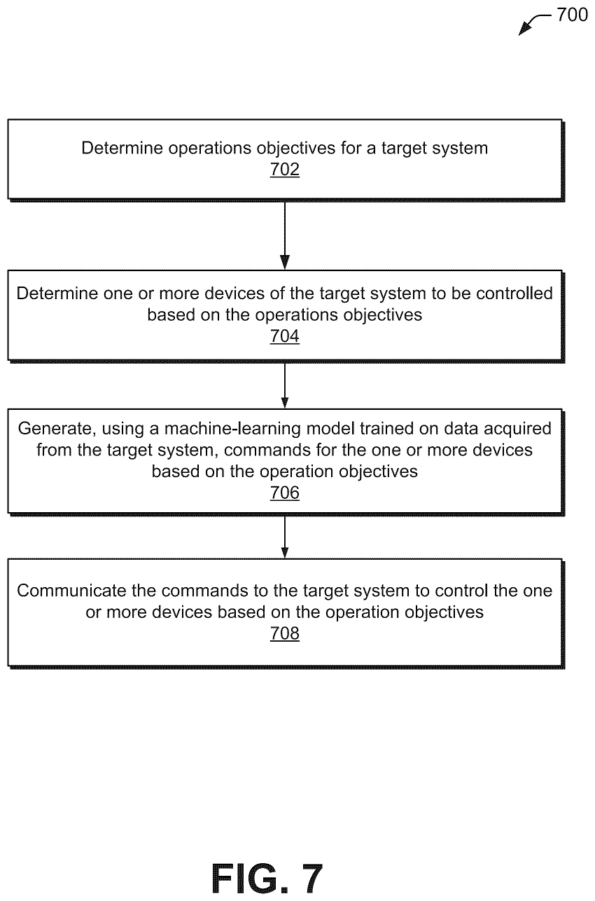

FIG. 7 depicts a procedure for implementing the platform 104 for coordinated device operation. The procedure 700 includes multiple operations illustrated as block 702 through block 708 and provides just one example procedure performed within any of the previously described systems (e.g., the management system 102). The procedure 700 is not limited to the order of operations shown in FIG. 7, and other orderings of blocks 702 through 708 are possible. In one or more implementations, the procedure 700 includes additional or fewer operations than those depicted in FIG. 7.

Operation objectives for a target system are determined at block 702. By way of example, the operation objectives 210 for the target system 116 are communicated to the machine-learning model 142 of the management system 102 via user input applied to the user interface 406 of the platform 104.

One or more devices of the target system to be controlled are determined based on the operation objectives at block 704. By way of example, the machine-learning model 142 determines the target devices 124 to be controlled based on the operation objectives 210. For example, the operation objectives 210 may specify an instruction to “maintain facility air temperature while increasing access for authorized vehicles approaching the facility.” Based on the instruction in the operation objectives 210, the machine-learning model 142 determines that the target devices 124 include at least the powered door 114 and an air conditioning device (e.g., a cooler and/or heater) of the facility 106.

Commands for the one or more devices are generated based on the operation objectives using a machine-learning model trained on data received from the target system at block 706. By way of example, the machine-learning model 142 generates commands 122 for the target devices 124 based on the operation objectives 210. In the example described above, the machine-learning model 142 generates commands for each of the powered door 114 and the air conditioning device. The commands are communicated to the target system to control the one or more devices based on the operation objectives at block 708. By way of example, the management system 102 communicates the commands 122 to the target devices 124 of the target system 116 using network 118.

Referring to FIG. 8, an example system 800 is depicted that includes an example computing device 802 that is representative of one or more computing systems and/or devices that are usable to implement the various techniques described herein. This is illustrated through implementation of the management system 102 via the computing device 802. The computing device 802 is configured as, for example, a server, a device associated with a client (e.g., a client device), an on-chip system, and/or any other suitable computing device or computing system.

The example computing device 802 as illustrated includes a processing system 804, one or more computer-readable media 806, and one or more input/output interfaces 808 (I/O interfaces) that are communicatively coupled, one to another. Although not shown, the computing device 802 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that are configured as processors, functional blocks, and so forth. This includes example implementations in hardware as a system specific integrated circuit or other logic device formed using one or more semiconductors. The hardware elements 810 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 806 is illustrated as including memory/storage 812. The memory/storage 812 represents memory/storage capacity associated with one or more computer-readable media. In one example, the memory/storage 812 includes volatile media (such as random access memory (RAM)) and/or nonvolatile media (such as read only memory (ROM), Flash memory, optical disks, magnetic disks, and so forth). In another example, the memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

The input/output interface(s) 808 are representative of functionality to allow user input to enter commands and information to the computing device 802, and also allow information to be presented and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The one-or-more computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 810 and the computer-readable media 806 are representative of modules, programmable device logic and/or fixed device logic implemented in a hardware form that is employable in some implementations to implement at least some aspects of the techniques described herein, such as to perform one or more instructions. Hardware includes components of an integrated circuit or on-chip system, a system-specific integrated circuit (ASIC), a field-programmable gate array (FPGA), a complex programmable logic device (CPLD), and other implementations in silicon or other hardware. In this context, hardware operates as a computing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more of the hardware elements 810. For example, the computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or the hardware elements 810 of the processing system 804. The instructions and/or functions are executable/operable by one or more articles of manufacture (for example, one or more computing devices such as computing device 802 and/or processing systems such as processing system 804) to implement techniques, modules, and examples described herein. The techniques described herein are supportable by various configurations of the computing device 802 and are not limited to the specific examples of the techniques described herein. This functionality is also implementable entirely or partially through use of a distributed system, such as over the cloud 120.

The cloud 120 includes and/or is representative of the platform 104 for resources 818. The platform 104 abstracts underlying functionality of hardware (e.g., servers) and software resources of the cloud 120. For example, the resources 818 include systems and/or data that are utilized while computer processing is executed on servers that are remote from the computing device 802. In some examples, the resources 818 also include services provided over the Internet and/or through a subscriber network, such as a cellular or Wi-Fi network.

The platform 104 abstracts the resources 818 and functions to connect the computing device 802 with other computing devices. In some examples, the platform 104 also serves to abstract scaling of resources to provide a corresponding level of scale to encountered demand for the resources that are implemented via the platform 104. Accordingly, in an interconnected device implementation, implementation of functionality described herein is distributable throughout the system 800. For example, the functionality is implementable in part on the computing device 802 as well as via the platform 104 that abstracts the functionality of the cloud 120. Many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the management system 102 and target system 116) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a DSP, a GPU, a parallel accelerated processor, a plurality of microprocessors, one or more microprocessors in association with a DSP core, a controller, a microcontroller, Application Specific Integrated Circuits (ASICs), FPGAs, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a ROM, a RAM, a register, cache memory, semiconductor memory devices, magnetic media such as internal hard disks and removable disks, magneto-optical media, and optical media such as CD-ROM disks, and digital versatile disks (DVDs).

What is claimed is:

1. A system, comprising:
at least one memory storing instructions thereon; and
at least one processor configured to execute the instructions to:
determine operation objectives for a target system;
determine one or more devices of the target system to be controlled based on the operation objectives;
generate, using a machine-learning model trained on data received from the target system, commands for the one or more devices based on the operation objectives; and
communicate the commands to the target system to control the one or more devices based on the operation objectives.

2. The system of claim 1, wherein the machine-learning model is trained to process natural language input, determine the operation objectives from the natural language input, and determine the one or more devices of the target system to be controlled based on the operation objectives.

3. The system of claim 1, wherein the at least one processor is configured to:
determine one or more external devices outside of the target system based on historical operation data of the target system describing interactions between the one or more external devices and the one or more devices of the target system; and
generate, using the machine-learning model, the commands for the one or more devices further based on the interactions described by the historical operation data.

4. The system of claim 1, wherein the at least one processor is configured to determine constraints of the one or more devices from the data and generate the commands further based on the constraints.

5. The system of claim 1, wherein the data includes sensor data of the one or more devices.

6. The system of claim 1, wherein the at least one processor is configured to:
receive operational data from the target system following communication of the commands to the target system;
determine whether the operation objectives are satisfied based on the operational data; and
responsive to the operation objectives not being satisfied:
generate, using the machine-learning model, updated commands based on the operational data; and
communicate the updated commands to the target system.

7. The system of claim 1, wherein the operation objectives specify at least one target condition for the target system, and the commands include instructions executable by the one or more devices to cause the one or more devices to adjust a condition of the target system to satisfy the at least one target condition.

8. The system of claim 1, wherein each device of the one or more devices includes a respective application, and the at least one processor is configured to communicate the commands to the target system to control the one or more devices based on the operation objectives by communicating the commands to each respective application.

9. The system of claim 8, wherein each application is encoded with a respective application programming interface (API), and the machine-learning model determines the commands based on each API.

10. The system of claim 1, wherein the data describes one or more applications associated with the one or more devices, the one or more applications configured to execute instructions to cause the one or more devices to perform operations specified by the instructions.

11. The system of claim 10, wherein the at least one processor is configured to generate one or more simulated applications, with each simulated application corresponding to a respective application of the one or more applications associated with the one or more devices.

12. The system of claim 11, wherein the data includes application programming interface (API) data of the one or more applications and constraint data of the one or more applications; and
the at least one processor is configured to:
generate the one or more simulated applications using the API data and the constraint data, the one or more simulated applications based on the one or more applications associated with the one or more devices;
generate simulated commands including instructions to be executed by the one or more simulated applications; and
train the machine-learning model using outcomes resulting from execution of the instructions of the simulated commands by the one or more simulated applications to generate the commands for the one or more devices.

13. The system of claim 11, wherein the data includes historical operation data of the target system describing outcomes resulting from execution of instructions by the one or more applications; and
the at least one processor is configured to:
generate the one or more simulated applications using the historical operation data, the one or more simulated applications based on the one or more applications associated with the one or more devices;
generate simulated commands including instructions to be executed by the one or more simulated applications; and
train the machine-learning model using outcomes resulting from execution of the instructions of the simulated commands by the one or more simulated applications to generate the commands for the one or more devices.

14. The system of claim 1, further comprising maintaining a log in the at least one memory including data describing the commands communicated to the target system; and
the at least one processor is configured to:
receive user input for updating the log, the user input specifying adjustments to the commands;
generate updated commands based on the adjustments using the machine-learning model; and
communicate the updated commands to the target system.

15. A non-transitory computer-readable storage medium including instructions stored thereon that when executed by one or more processors, causes the one or more processors to:
determine operation objectives for a target system;
determine one or more devices of the target system to be controlled based on the operation objectives;
generate, using a machine-learning model trained on data received from the target system, commands for the one or more devices based on the operation objectives; and
control operation of the one or more devices based on the operation objectives by communicating the commands to the one or more devices.

16. The non-transitory computer-readable storage medium of claim 15, wherein the instructions cause the one or more processors to determine constraints of the one or more devices and a respective application programming interface (API) associated with each device.

17. The non-transitory computer-readable storage medium of claim 15, wherein the instructions cause the one or more processors to determine the operation objectives from natural language input using the machine-learning model.

18. A method, comprising:
determining, by a computing device, operation objectives for a target system;
determining, by the computing device, one or more devices of the target system to be controlled based on the operation objectives;
generating, using a machine-learning model trained on data received from the target system, commands for the one or more devices based on the operation objectives; and
controlling, by the computing device, operation of the one or more devices based on the operation objectives by communicating the commands to the one or more devices.

19. The method of claim 18, wherein the operation objectives specify at least one target condition for the target system, and the commands include instructions executable by the one or more devices to cause the one or more devices to perform operations to adjust the target system to satisfy the at least one target condition.

20. The method of claim 18, further comprising receiving natural language input via the computing device, and determining the operation objectives for the target system includes processing the natural language input via the machine-learning model.
